(19) United States
(12) Patent Application Publication
(10) Pub. No.: US 2026/0259903 A1
(43) Pub. Date: Sep. 3, 2026

(54) SYSTEMS, METHODS, AND APPARATUS FOR A HYBRID SOCIAL-ARTIFICIAL-INTELLIGENCE INTERACTION PLATFORM WITH AXIOM-LOCKED RETRIEVAL, REAL-TIME VOICE DUPLEX, FIDELITY VALIDATION, AND IN-FEED MULTIMODAL CONTENT GENERATION

(71) Applicant: CHUANPING HU, Pittsburg, KS (US)

(72) Inventor: CHUANPING HU, Pittsburg, KS (US)

(21) Appl. No.: 19/654,305

(22) Filed: Apr. 21, 2026

(51) Int. Cl. G06F 16/3329; G06Q 30/018; G10L 15/22

(52) U.S. Cl. CPC G06F 16/33295; G06Q 30/018; G10L 15/22

(57) ABSTRACT

A computer-implemented hybrid social-artificial-intelligence interaction platform is disclosed. The platform maintains a user within an active social context while providing an always-available AI invocation interface for text, speech, or mixed-modality queries. A retrieval controller accesses an authoritative axiom corpus, a response-generation engine produces a candidate response, and a fidelity validator verifies support, contradiction status, and publication eligibility before output. A session context buffer preserves feed, chat, group, live-stream, or short-video continuity during invocation and response delivery. Validated responses are rendered as text, speech, cards, dashboards, subtitles, or action lists and can be transformed in-session into posts, messages, short videos, overlays, or other publishable artifacts through a multimodal publishing pipeline. The system may further provide compliance indicators, action buttons, provenance records, elderly-accessibility adaptations, offline cache synchronization, and protected response modes that restrict generation to an authoritative corpus-bound AI engine for safer, traceable, socially integrated AI assistance.

### CROSS-REFERENCE TO RELATED APPLICATIONS

This application is related to, and may claim priority to or otherwise be coordinated with, one or more applications directed to lifecycle guidance platforms, long-term memory architectures, relationship-graph systems, companion-support systems, human-artificial-intelligence continuity systems, social-artificial-intelligence integration systems, and/or human-support workflow systems, the disclosures of which are incorporated herein by reference to the extent not inconsistent herewith.

In particular, this application is related to and may be coordinated with the patent applications entitled “COMPUTER-IMPLEMENTED ANXIETY-TO-ACTION SUPPORT SYSTEM WITH AXIOMATIC SAFETY ALIGNMENT, MULTI-MODEL EVALUATION, AND ADAPTIVE INTENSITY REGULATION” and “SYSTEMS AND METHODS FOR INTERSTELLAR DISTRIBUTED LIFE REDUNDANCY AND SPECIES 2.0 STATE SYNCHRONIZATION SYSTEM WITH GROUND-TO-SPACE IDENTITY ANCHORING, SPACEBORNE MULTI-AGENT VERIFICATION, AND CIVILIZATION-SEED AUTONOMOUS CONTINUITY,” the entire disclosures of which are incorporated herein by reference.

### BACKGROUND OF THE INVENTION

### Field of the Invention

The present invention relates generally to social computing, human-computer interaction, large-language-model orchestration, retrieval-augmented generation, multimodal publishing, and voice-enabled user interfaces. More particularly, the invention relates to systems, methods, and apparatus for integrating an artificial-intelligence response system directly into a social application such that a user may ask questions, receive validated responses, and publish AI-assisted output without leaving an active social interaction context.

### Description of the Related Art

Conventional social applications and conventional artificial-intelligence applications remain structurally separate. A user commonly discovers a post, video, or message in a social application, exits or context-switches to a separate chatbot or search tool, reformulates a question, obtains an answer of uncertain provenance, and then manually returns to the original social application to post or share content. This fragmentation imposes high cognitive load, increases context loss, and particularly burdens elderly, low-literacy, or non-technical users.

Existing social applications may provide recommendation engines, search bars, or limited assistant functions, but they do not provide a persistent, in-context, corpus-locked question-and-answer architecture that remains continuously available across feed browsing, short-video consumption, chat, groups, live-stream participation, and post creation. Existing chatbot products, by contrast, may provide strong conversational capability, but they are typically detached from social publishing flow, do not preserve in-feed continuity, and often generate responses without a dedicated fidelity-verification stage against an authoritative bounded knowledge corpus.

Further, when AI-generated content is created in separate applications, publication back into a social environment usually requires copying, editing, exporting, and re-uploading. This multi-step process slows user engagement, weakens viral spread, and causes mismatch between the original question, the authoritative answer, and the final published artifact.

There remains a need for a unified platform that: (i) embeds AI interaction directly within the social session, (ii) retrieves and generates from an authoritative bounded corpus, (iii) validates answer faithfulness before output, (iv) supports voice-first interaction for ordinary users, and (v) converts answers into publishable multimodal artifacts with one or a few actions.

The present invention serves as the primary human interface for Human Civilization 5.0 and the gateway to Human Species 2.0, an epoch defined by Dr. Frank Hu's patent-protected 600+ axioms. This new civilizational paradigm is characterized by radical material abundance, a tenfold to hundredfold expansion of global GDP, the liberation of human potential through optional work, widespread healthy longevity, and the complete eradication of poverty. It transforms existence from a zero-sum struggle into a collaborative journey toward “heart's desire fulfilled” and the realization of “heaven on earth in this lifetime.” To make this vision accessible to the entire global population of 8.3 billion—including the elderly, the low-literacy, the technologically disenfranchised, and the 500-700 million most vulnerable—a new kind of platform is required. The disclosed hybrid social-artificial-intelligence interaction platform directly fulfills this need by embedding authoritative, axiom-locked guidance into the familiar and daily context of social interaction, thereby democratizing access to the certainty and hope of Civilization 5.0.

### BRIEF SUMMARY OF THE INVENTION

The present invention provides a hybrid social-artificial-intelligence interaction platform that seamlessly combines social networking functionality with a dedicated AI response engine tied to an authoritative corpus.

In one aspect, the invention provides a system comprising: (a) a social session manager configured to maintain a user within an active social context selected from a feed, short-video interface, chat session, group interface, live stream, story interface, event page, or comment thread; (b) an AI invocation interface comprising an always-available interaction control accessible without leaving the active social context; (c) an input processor configured to receive a user query in text, speech, or mixed modality; (d) an axiom corpus store containing an authoritative knowledge corpus; (e) a retrieval controller configured to retrieve one or more corpus segments responsive to the user query; (f) a response-generation engine configured to generate a candidate response based on at least the user query and the retrieved corpus segments; (g) a fidelity validator configured to determine whether the candidate response satisfies one or more faithfulness constraints relative to the authoritative corpus; (h) an output renderer configured to render a validated response as text, speech, graphical cards, dashboards, action lists, subtitles, or other user-consumable output; and (i) a multimodal publishing pipeline configured to transform at least part of the validated response into a publishable social artifact within the same application.

In another aspect, the invention provides a method by which a user, while remaining inside a social interface, invokes an AI assistant, receives an answer validated against an authoritative corpus, and converts that answer into a post, message, or video without leaving the active session.

In another aspect, the invention provides embodiments optimized for elderly and low-literacy users by including real-time speech transcription, simplified-language response rendering, text-to-speech playback with repeat and speed controls, full-duplex voice exchange, enlarged controls, and optionally a wake phrase for hands-free invocation.

In another aspect, the invention provides a technical improvement to human-computer interaction by reducing context switching between social and AI applications, preserving session continuity, reducing user cognitive overhead, and improving the reliability of generated content through bounded retrieval and fidelity validation before publication.

In another aspect, the invention provides an extensible platform in which validated answers may be transformed automatically into multiple content formats, including a short social post, a long-form explanation, a share card, a chat reply, a narrated short video, a subtitle package, or a live-stream response overlay.

In further embodiments, the invention operates in a protected response mode in which all artificial-intelligence responses are generated solely by an H AI engine locked to an authoritative axiom corpus, and the system prohibits execution of any external third-party large language model API for generation of protected responses. In further embodiments, a compliance badge generator produces a visible pre-publication compliance indicator for each validated response, thereby allowing the system to prevent dissemination of output that fails one or more fidelity, support, contradiction, or compliance conditions.

In further embodiments, the invention further comprises an action-button generator configured to attach one or more actionable controls to guidance cards or dashboard panels derived from validated responses. Such controls may include at least one of Learn More, Apply This, Share This, Ask Follow-Up, Replay Spoken Guidance, or Route to Family or Group.

In further embodiments, the invention further comprises structured provenance objects including a user invocation event record, a query object, retrieval metadata, validation metadata, and a publish package. These objects permit full traceability from AI invocation through publication.

### BRIEF DESCRIPTION OF THE DRAWINGS

The present patent application comprises FIGS. 1 through 8, a total of 8 drawing figures. Like reference numerals in the drawings indicate identical or functionally similar components. This section provides sufficiently detailed graphical descriptions to enable any person skilled in the art to prepare formal patent drawings complying with the requirements of the United States Patent and Trademark Office.

FIG. 1 is a high-level block diagram of the hybrid social-artificial-intelligence interaction platform.

This figure should be drawn as a layered architecture block diagram. The top layer is the Social Interface Renderer 130 running on the user terminal device 110. Below it are the core backend modules of the system. From left to right or top to bottom, the following should be clearly labeled: Social Session Manager 120, AI Invocation Interface 140 (which includes the persistently displayed “Ask AI” Floating Control 150), Input Processor 160, Authoritative Axiom Corpus Store 200, Retrieval Controller 220, Response-Generation Engine 250, Fidelity Validator 270, Output Renderer 300, Multimodal Publishing Pipeline 340, and Provenance and Audit Module 390. Between the Social Session Manager 120 and the AI Invocation Interface 140, a Session Context Buffer 190 should be emphasized, indicating its ability to preserve user session state. Arrows should clearly indicate the data flow from user input to response generation, validation, rendering, and multimodal publishing. The newly added Compliance Badge Generator 400, Action-Button Generator 450, and Elderly Mode Controller 430 are connected as subsystems to the Output Renderer 300 and the Multimodal Publishing Pipeline 340.

FIG. 2 is a user-interface flow diagram showing a user scrolling a feed, invoking an AI assistant through a persistent floating control, asking a question, receiving an answer, and publishing a derived artifact without leaving the active session. This figure should be drawn as a series of screen state transition diagrams. The starting state is S210: A user is browsing a vertical short-video feed. On this screen, a persistent “Ask AI” Floating Button 150 is displayed. State S220: The user taps the Floating Button 150. State S230: An interaction panel slides up from the bottom or center of the screen for inputting a query, with the background short-video feed still visible but possibly partially obscured by a semi-transparent overlay. State S240: The user enters a text or voice query into the interaction panel. State S250: After system processing, a validated response is rendered 300 in the same panel. State S260: The user taps a “One-Tap Publish” button 350 below the response. State S270: The system displays a publication preview interface, and upon confirmation, the content is published. State S280: The interaction panel retracts, the user returns to the original feed interface, and a temporary “Published” notification appears at the top. The entire flow should be connected with arrows and annotated with key component numbers.

FIG. 3 is a pipeline diagram showing query intake, corpus retrieval, candidate generation, fidelity validation, response rendering, and publishing transformation. This figure is a linear pipeline diagram. It begins with “Query Intake Q1,” with an arrow pointing to “Text Query Parser 180” or “Speech-to-Text Engine 170.” Next is the “Retrieval Stage R1,” where the Retrieval Controller 220 queries the Authoritative Axiom Corpus Store 200 and utilizes the Embedding and Similarity Engine 230. Retrieved corpus segments enter the “Prompt Assembly Stage P1” (Module 240). The assembled prompt enters the “Generation Stage G1,” where the Response-Generation Engine 250 outputs a Candidate Response Object 260. The Candidate Response Object enters the “Validation Stage V1,” undergoing evaluation by the Support-Score Engine 280 and the Contradiction Detector 290. Upon passing validation (Decision Box D1), it becomes a Validated Response and proceeds to the “Output Rendering Stage O1.” Finally, the Validated Response flows into the “Publishing Stage PUB1,” where it is transformed into a publishable social artifact within the Multimodal Publishing Pipeline 340. All key data objects (e.g., Query Object, Retrieval Metadata, Validation Metadata) should be indicated in small boxes adjacent to the corresponding stages.

FIG. 4 is a voice-first interaction diagram including speech capture, streaming transcription, response generation, text-to-speech playback, replay control, and wake-phrase re-entry. This figure is a flowchart emphasizing voice interaction. It begins at S410: The user is engaged in an active social session. The user speaks a wake phrase detected by the Wake-Phrase Listener 440 (e.g., “Hey H App”) or manually taps the Ask AI Button 150. S420: The user speaks a query; the speech is captured and streamed for real-time transcription 170. S430: The system processes the query and generates a validated response. S440: The response is read aloud to the user via the Text-to-Speech Engine 320, while synchronized text is displayed on the screen. S450: The Voice Interaction Controller provides playback controls (pause, replay, speed adjustment). The user can then speak a follow-up command, such as “publish,” or re-enter a new query via the wake phrase. For Elderly Mode 430, the specific interface elements it triggers, such as enlarged buttons and high-contrast themes, should be indicated with a dashed box in the figure.

FIG. 5 is a multimodal publishing diagram showing transformation of a validated response into a post, message, short video, card, or live-stream overlay. This figure centers on a Validated Response Object R1. From R1, a Content Classifier 510 directs the data flow to different transformation modules based on content characteristics. These modules should be drawn side-by-side, including: Post Composer 350, Short-Video Generator 360, Subtitle Generator 370, Message/Reply Transformer 470, Live-Stream Overlay Generator 480, and Group or Chat Publishing Adapter 490. Each module outputs a Draft Package 520. All draft packages are aggregated into a “Preview and Publish” interface. Upon user confirmation, the content is distributed to Social Destinations 530 (e.g., Feed, Story, Chat). The figure should show how the Short-Video Generator 360 invokes the Text-to-Speech Engine 320 and the Dashboard Generator 330 to synthesize a video.

FIG. 6 is a personalized dashboard and safety-compliance diagram showing one or more status indicators, guidance cards, action buttons, and an axiom compliance badge. This figure should simulate a dashboard interface within a mobile application. At the top of the interface is a User Status Summary 610. Below it are multiple Guidance Cards 620, each containing a concise answer or suggestion, along with buttons generated by the Action-Button Generator 450 (e.g., “Learn More,” “Apply This Suggestion”). A prominent Safety Shield Visual Indicator 630, generated by the Compliance Badge Generator 400, is displayed, using a green or highlighted color to indicate content verification. At the bottom or side is a Provenance Section 640, which can be expanded to view the axiom sources cited in the answer. The interface also includes an Elderly or Accessibility Mode Toggle 650, represented by a distinct icon.

FIG. 7 is a data-structure diagram illustrating a query object, retrieved corpus segments, validation metadata, response object, publish package, and provenance log entries. This figure is an entity-relationship diagram or object structure diagram. Each data object is represented by a box, inside which key fields are listed. For example, “User Invocation Event Record 710” contains Event ID, User ID, Timestamp, Invocation Type, Social Context. “Query Object 720” contains Raw Query Text, Normalized Text. “Retrieval Metadata 730” contains Corpus Segment ID, Relevance Score. “Validation Metadata 740” contains Fidelity Score, Contradiction Status, Validation Decision. “Validated Response Object 750” contains Final Text and Formatting Information. “Publish Package 760” contains Final Artifact, Source Response Reference, Publication Destination. Connecting lines with arrows should indicate the association and reference relationships between data objects. For instance, a “Publish Package 760” points to a “Validated Response Object 750,” which in turn points to “Validation Metadata 740” and “Retrieval Metadata 730.” At the bottom, all records are aggregated into “Provenance Log Entries 770.”

FIG. 8 is an enhanced scenario flow diagram combining voice-first interaction with offline cache synchronization and follow-up guidance delivery. This figure combines the voice process of FIG. 4 with offline capabilities and follow-up guidance. It begins with the user device in an offline or weak network state. The user triggers the AI via a wake word, and the system provides a provisional answer based on limited local axiom fragments via the Offline Cache 410. When the network is restored, the Synchronization Controller 420 uploads the query records and publish packages from the offline period to the cloud and downloads more complete answers or updated axiom libraries. Simultaneously, based on previous queries, the system proactively pushes related follow-up questions or in-depth content to the user at a later time via Guidance Cards 620, forming a closed loop from “instant Q&A” to “deferred deep learning.” The figure should clearly distinguish between “Offline State” and “Online State” areas and use different line types to represent data flows for local processing and cloud synchronization.

### REFERENCE NUMERALS

To enable persons skilled in the art to accurately and unambiguously draw and understand the present invention, the following detailed list of reference numerals is provided:
100 Hybrid social-AI interaction platform
110 Client device
120 Social session manager
130 Social interface renderer
140 AI invocation interface
150 Floating Ask AI control
160 Input processor
170 Speech-to-text engine
180 Text query parser
190 Session context buffer
200 Authoritative axiom corpus store
210 Corpus segments
220 Retrieval controller
230 Embedding and similarity engine
240 Prompt assembly module
250 Response-generation engine
260 Candidate response object
270 Fidelity validator
280 Support-score engine
290 Contradiction detector
300 Output renderer
310 Simplified-language renderer
320 Text-to-speech engine
330 Dashboard generator
340 Multimodal publishing pipeline
350 Post composer
360 Short-video generator
370 Subtitle generator
380 Share/export controller
390 Provenance and audit module
400 Compliance badge generator [New]
410 Offline cache
420 Synchronization controller
430 Elderly mode controller [Enhanced]
440 Wake-phrase listener
450 Action-button generator [New]
460 User profile state store
470 Message/reply transformer
480 Live-stream overlay generator
490 Group or chat publishing adapter
510 Content classifier
520 Draft package
530 Social destination
610 User status summary
620 Guidance cards
630 Safety shield visual indicator
640 Provenance section
650 Elderly or accessibility mode toggle
710 User invocation event record
720 Query object
730 Retrieval metadata
740 Validation metadata
750 Validated response object
760 Publish package
770 Provenance log entries

### DETAILED DESCRIPTION OF THE INVENTION

### I. Introduction and Definitions

The present invention is directed to a comprehensive platform for hybrid social and artificial-intelligence interaction. The invention uniquely integrates a social application front end with an authoritative-corpus retrieval system, a response generation system, a fidelity-verification system, and an in-session content-publication system.

As used herein, the term “social session” means any user interaction state in which a user is browsing, consuming, creating, reacting to, or communicating through social content, including but not limited to scrolling a feed, watching a short video, entering a comment thread, participating in a chat, joining a group, or viewing a live stream.

As used herein, the term “authoritative axiom corpus” means a bounded corpus designated by the system as an authoritative source for at least one operating mode of response generation.

As used herein, the term “fidelity validation” means a post-generation or concurrent verification process by which a candidate response is evaluated for support, consistency, traceability, or contradiction relative to the authoritative axiom corpus.

As used herein, the term “in-feed” means that the user remains in the current social interface without forced navigation to a separate application or a separate primary interaction workspace.

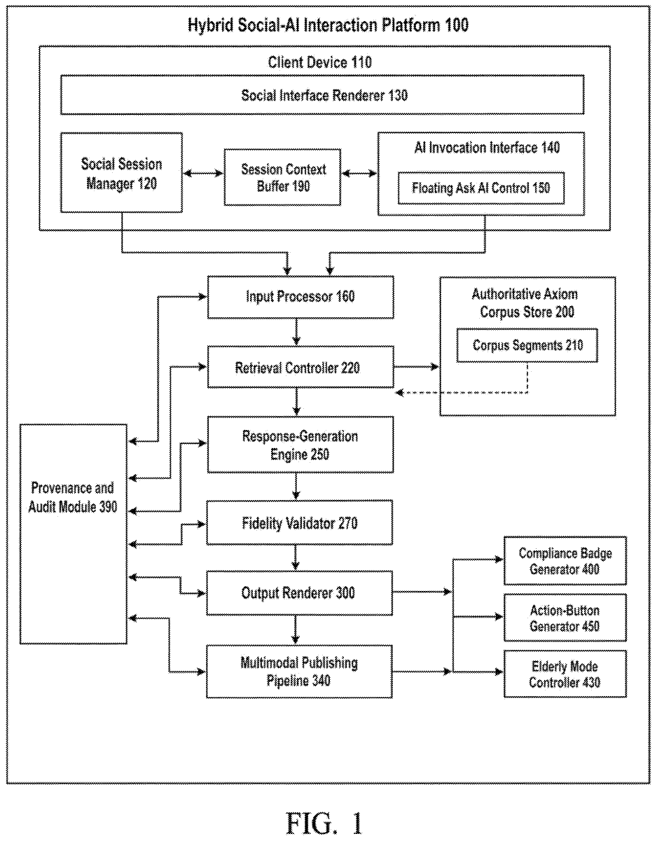

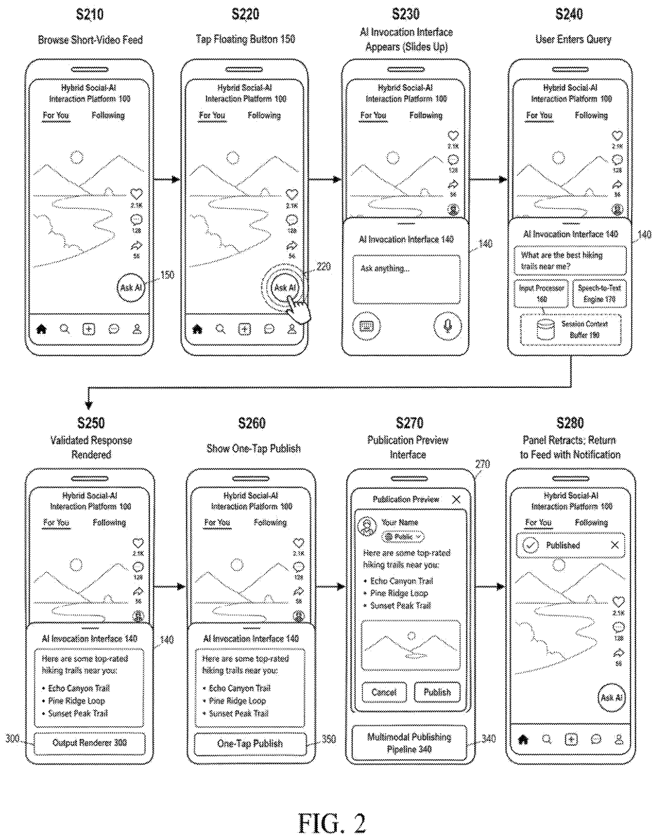

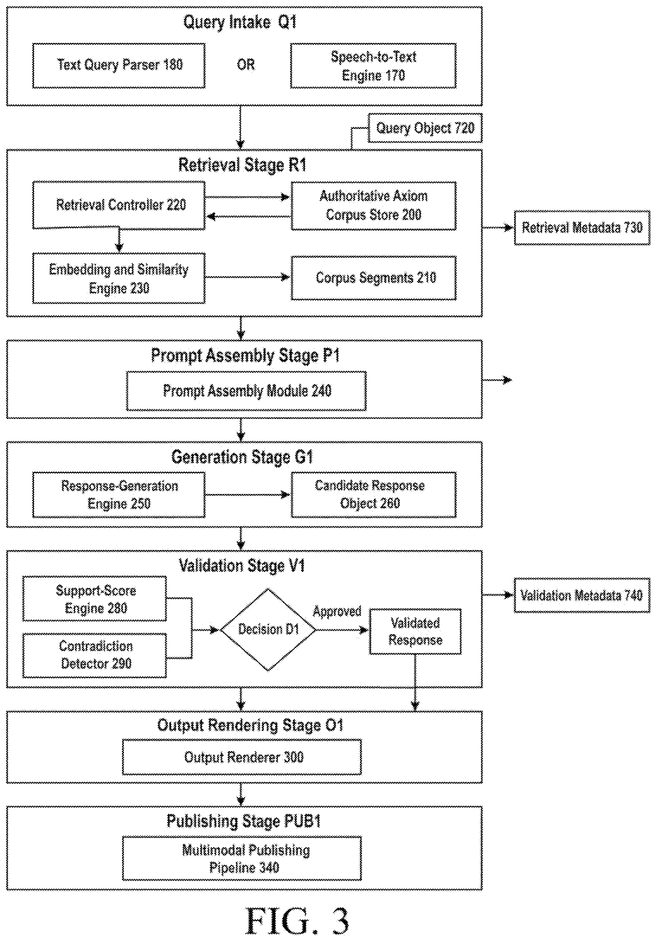

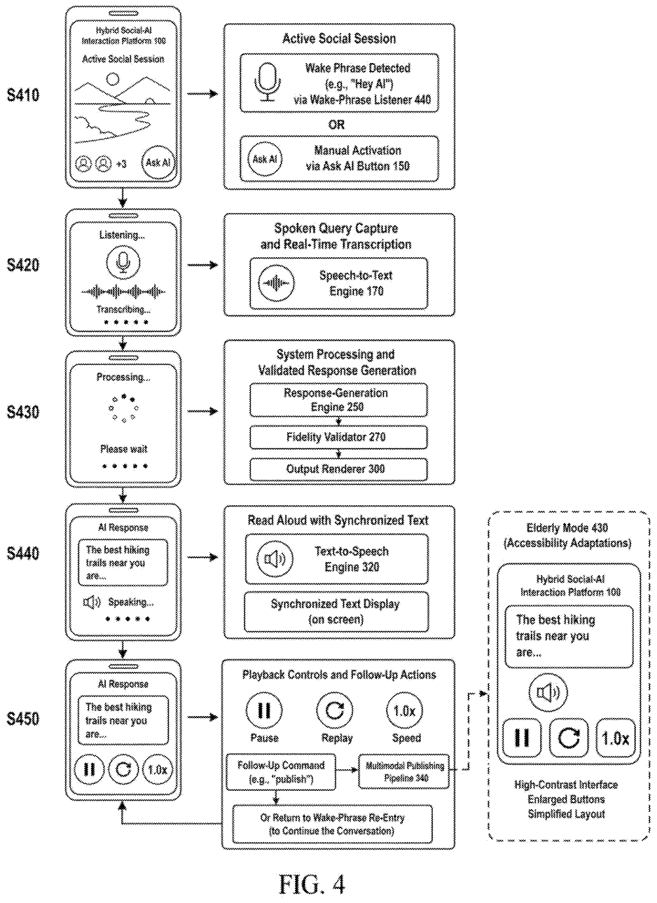

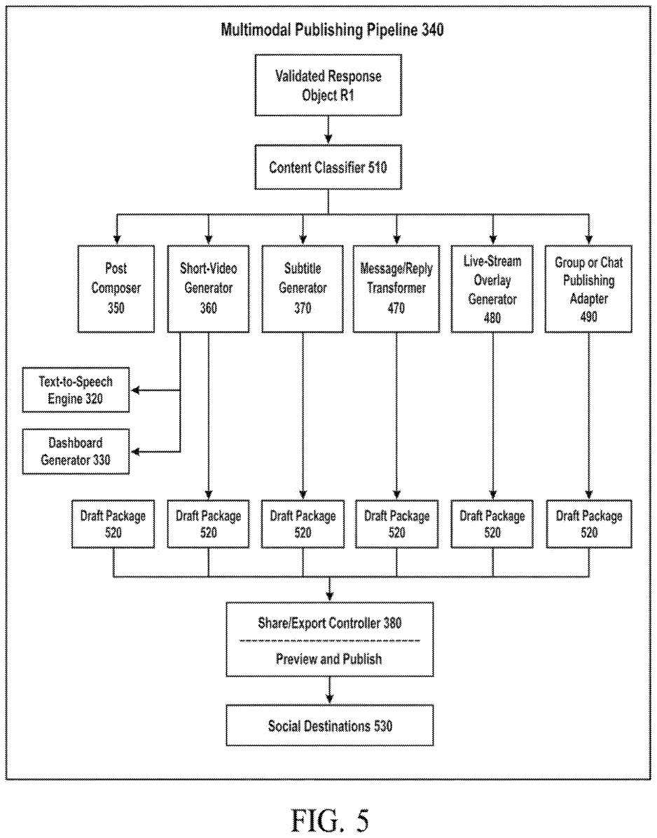

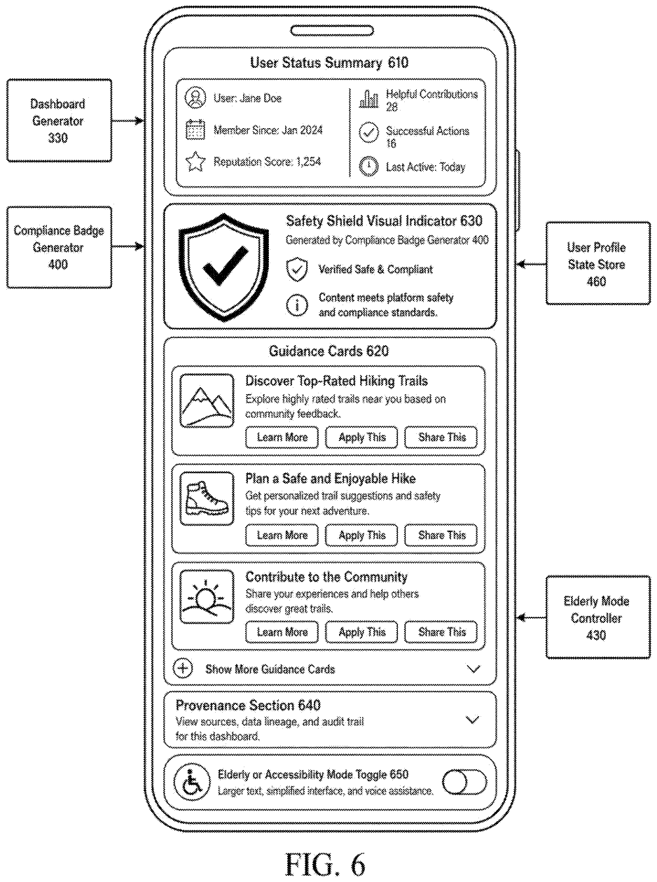

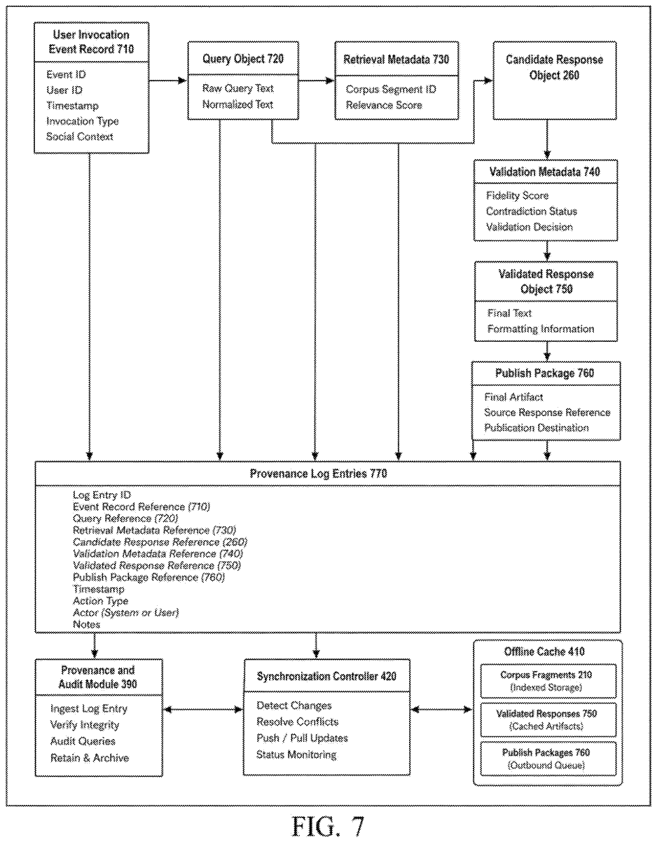

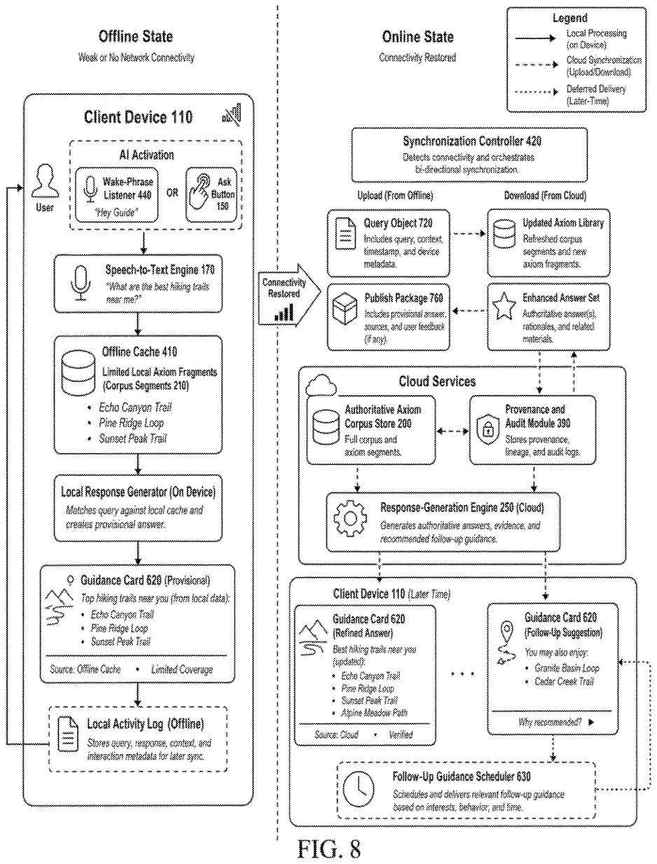

### II. System Overview (FIG. 1)

Referring to FIG. 1, the hybrid social-AI interaction platform 100 comprises one or more client devices 110 communicating with one or more servers or cloud components implementing the social session manager 120, social interface renderer 130, AI invocation interface 140, authoritative axiom corpus store 200, retrieval controller 220, response-generation engine 250, fidelity validator 270, output renderer 300, multimodal publishing pipeline 340, and provenance and audit module 390.

The social session manager 120 maintains a current user session state including the active interface, visible content, active thread or feed position, active contacts or group membership, and recently observed user interactions. The session context buffer 190 stores at least part of the current UI context so that a user may invoke AI assistance without losing session continuity.

The AI invocation interface 140 presents a persistent or selectively persistent interaction entry point, such as floating Ask AI control 150, bottom toolbar control, swipe gesture, long-press region, or voice activation. In preferred embodiments, the user may invoke AI assistance during feed scrolling, video playback, chat, or live-stream participation.

The authoritative axiom corpus store 200 contains a bounded knowledge base used in at least one operating mode as the sole or primary source of truth. The corpus may be divided into corpus segments 210, each of which may be tagged by topic, priority, confidence level, language, audience type, or usage scope.

The retrieval controller 220 receives a parsed query and uses embedding and similarity engine 230 to identify relevant corpus segments 210. In some embodiments, the retrieval controller applies lexical retrieval, semantic retrieval, or hybrid retrieval. The retrieval controller may also use session context, user profile attributes from user profile state store 460, language preference, or active social-context metadata to refine retrieval.

Prompt assembly module 240 constructs a structured prompt for response-generation engine 250. The prompt may include one or more retrieved corpus segments, one or more operating instructions, one or more formatting directives, one or more safety directives, and one or more audience-adaptation settings.

The response-generation engine 250 produces a candidate response object 260 based on the structured prompt and one or more retrieved corpus segments. Candidate response object 260 may include plain text, structured bullet output, a JSON response, a script outline, a card layout instruction, a video storyboard instruction, or a speech-oriented answer.

The fidelity validator 270 examines candidate response object 260 before final delivery. In one embodiment, support-score engine 280 determines whether propositions in candidate response object 260 are sufficiently supported by retrieved corpus segments 210. In another embodiment, contradiction detector 290 determines whether candidate response object 260 contradicts retrieved corpus segments 210 or one or more protected system constraints. The fidelity validator 270 may then approve, reject, revise, annotate, or confidence-score the candidate response.

Output renderer 300 displays the validated response within the active social session. The response may be rendered as plain text, synchronized text plus audio, a visual card, a dashboard, a step list, a choice flow, a reply suggestion, a summary, or a structured plan. Dashboard generator 330 may convert the validated response into one or more user-facing visual indicators.

The multimodal publishing pipeline 340 transforms a validated response into a publishable social artifact without requiring the user to leave the social application. The publishable artifact may be sent to post composer 350, short-video generator 360, message/reply transformer 470, or live-stream overlay generator 480.

The provenance and audit module 390 stores information sufficient to reconstruct at least part of the AI-assisted content-generation process. Compliance badge generator 400 may generate a visible indicator showing that the output passed one or more corpus-fidelity or system-compliance checks.

Offline cache 410 stores selected corpus fragments, query templates, prior validated responses, or user-preferred guidance bundles. Synchronization controller 420 uploads queued audit entries and publication events when connectivity returns.

For users with limited literacy, low digital familiarity, or age-related accessibility needs, elderly mode controller 430 applies one or more adaptations. Simplified-language renderer 310 transforms output into a readability-adjusted format. Text-to-speech engine 320 provides spoken output.

In certain embodiments, the system operates in a protected response mode that excludes any non-authoritative external model source. In this mode, all protected responses are generated solely by an H AI engine constrained to the authoritative axiom corpus, and no external third-party large language model API is permitted to generate or substitute the protected response. This architecture ensures that validated output remains corpus-bound, traceable, and compliant with the designated governance rules of the system.

In certain embodiments, the fidelity validator is configured not only to approve, reject, revise, annotate, or confidence-score a candidate response, but also to assign a publication-eligibility state. A candidate response that fails one or more support, contradiction, safety, or compliance requirements may be rendered for user inspection in a non-publishable state, revised automatically, or withheld from dissemination until the required condition is satisfied.

In certain embodiments, the system further comprises a compliance badge generator that generates a visible compliance state for a validated response. The visible compliance state may be presented as a badge, shield, icon, status bar, or other on-screen compliance indicator and may be displayed in a preview pane, dashboard panel, or one-tap publication control area prior to publication.

### III. Social Layer and Session Continuity (FIG. 2)

Referring now to FIG. 2, a user-interface flow diagram illustrates how a user interacts with the hybrid social-AI interaction platform 100 while remaining within a continuous social session. The process begins with the user operating a client device 110 that displays a social interface rendered by social interface renderer 130.

In step S210, the user is engaged in an active social session managed by social session manager 120. The social interface may take any of the forms enumerated in the definition of “social session,” such as scrolling a vertical short-video feed, browsing a real-time discussion feed, participating in a private chat or group chat, reading or composing comments in a comment thread, viewing a story, or watching a live stream.

In step S220, while the user remains within the active social session, the system displays an AI invocation interface 140 that is persistently available. In the preferred embodiment shown, the AI invocation interface 140 takes the form of a floating Ask AI control 150 that overlays the social interface content. The floating Ask AI control 150 is designed to be unobtrusive yet readily accessible, allowing the user to invoke artificial-intelligence assistance with a single tap, click, or voice command, without navigating away from the current social view. The session context buffer 190 continuously preserves the user's position within the social session (e.g., scroll position in a feed, playback timestamp in a video, or active message thread).

In step S230, the user activates the AI invocation interface 140, for example by tapping the floating Ask AI control 150. In response, the system presents an interaction overlay, a split-pane interface, or an expandable drawer that coexists with the underlying social interface. Critically, the user is not redirected to a separate application or a distinct primary workspace; the social session remains active and visible beneath or adjacent to the newly presented AI interaction region.

In step S240, the user inputs a query using the input processor 160. The query may be entered as text via a keyboard or, in preferred embodiments, as speech captured by a microphone and transcribed in real time by speech-to-text engine 170. The user's query is received while the social interface content remains visible in the background, and the session context buffer 190 may augment the query with contextual metadata, such as the identity of a post that was on-screen at the time of invocation.

In step S250, the system processes the query through the retrieval controller 220, response-generation engine 250, and fidelity validator 270 to produce a validated response. This internal pipeline is described in greater detail with reference to FIG. 3.

In step S260, the output renderer 300 presents the validated response to the user within the same interaction overlay or panel. The response may be rendered as text, spoken output via text-to-speech engine 320, graphical cards generated by dashboard generator 330, or a combination thereof. The user may interact with the response (e.g., ask a follow-up question, request clarification, replay spoken output) without losing the underlying social session context.

In step S270, the user elects to share or publish content derived from the validated response. The multimodal publishing pipeline 340 transforms at least a portion of the validated response into a publishable social artifact. For instance, the user may tap a “Post” button, causing post composer 350 to create a feed post; or the user may tap a “Create Video” button, causing short-video generator 360 to automatically produce a narrated short video based on the response content.

In step S280, the publishable social artifact is posted to the user's social feed, shared in a chat, added to a story, or otherwise disseminated through the social session manager 120. Throughout this entire process, the user has not been forced to exit the active social session or manually context-switch between applications. After publishing, the user may dismiss the AI interaction overlay and immediately resume the social session at the exact position preserved by session context buffer 190.

### IV. Retrieval, Generation, and Fidelity Validation Pipeline (FIG. 3)

Referring now to FIG. 3, a pipeline diagram illustrates the flow of data and processing operations from query intake through response validation and publication. The pipeline may be executed on one or more servers, on the client device 110 in a hybrid or on-device configuration, or in a distributed cloud environment.

The process begins with query intake Q1. A user query is received via input processor 160. If the query is spoken, speech-to-text engine 170 converts the audio signal into text. Text query parser 180 normalizes the text, corrects typographical errors if appropriate, and may segment the query into discrete semantic components. The parsed query is then passed to retrieval controller 220.

At retrieval stage R1, the retrieval controller 220 interacts with authoritative axiom corpus store 200. The retrieval controller 220 employs embedding and similarity engine 230 to generate a vector representation of the parsed query and to identify one or more corpus segments 210 that are semantically relevant. In some embodiments, lexical retrieval, semantic retrieval, or hybrid retrieval techniques are applied. The retrieval controller 220 may also consider session context stored in session context buffer 190, user profile attributes from user profile state store 460, language preferences, or other metadata to refine the retrieval. The output of retrieval stage R1 is a set of one or more retrieved corpus segments 210.

At prompt assembly stage P1, prompt assembly module 240 constructs a structured input for the response-generation engine 250. The structured prompt includes at least the user's original or parsed query and the retrieved corpus segments 210. Additionally, the prompt may include system instructions that dictate the desired format, tone, audience adaptation (e.g., simplified language), safety constraints, and a directive to generate responses strictly derivable from the provided corpus segments.

At generation stage G1, response-generation engine 250 processes the structured prompt and produces a candidate response object 260. The response-generation engine 250 may be a large language model (LLM) or any other suitable generative model. Candidate response object 260 is not yet displayed to the user; it is an intermediate data structure containing the generated text, formatting metadata, and optionally structured output such as JSON for cards or dashboards.

At fidelity validation stage V1, fidelity validator 270 evaluates candidate response object 260. In a preferred embodiment, the fidelity validator 270 comprises two sub-modules: support-score engine 280 and contradiction detector 290. Support-score engine 280 computes a metric indicating the degree to which each proposition in the candidate response is supported by the retrieved corpus segments 210 or the broader authoritative axiom corpus store 200. Contradiction detector 290 identifies any statements in the candidate response that directly conflict with the authoritative axiom corpus. Based on the outputs of support-score engine 280 and contradiction detector 290, the fidelity validator 270 makes a determination to approve, reject, revise, annotate, or assign a confidence score to the candidate response.

If the candidate response passes validation (decision D1), it becomes a validated response and proceeds to output rendering stage O1. If it fails validation, the system may take remedial action, such as triggering a re-generation request with stricter constraints, applying automatic revision to remove unsupported claims, or returning a graceful failure message indicating that a faithful answer could not be generated from the authoritative corpus.

At output rendering stage O1, output renderer 300 prepares the validated response for presentation to the user. This may involve converting plain text into a visually formatted card, invoking simplified-language renderer 310 for low-literacy modes, or passing the text to text-to-speech engine 320 for spoken output. The rendered response is then displayed to the user within the active social session.

Finally, at publishing stage PUB1, if the user elects to publish content based on the validated response, the multimodal publishing pipeline 340 transforms the validated response into one or more publishable social artifacts. This stage may involve post composer 350, short-video generator 360, subtitle generator 370, or other components described in greater detail with reference to FIG. 5.

### V. Voice-First Interaction Mode (FIG. 4)

Referring now to FIG. 4, a voice-first interaction diagram illustrates an embodiment particularly suited for elderly users, low-literacy users, or any user who prefers hands-free operation. This mode leverages the voice interaction controller and related components to provide a seamless spoken dialogue within the social session.

The process begins at step S410, where the user is engaged in an active social session. While scrolling a feed, watching a video, or participating in a chat, the user may speak a wake phrase detected by wake-phrase listener 440. The wake phrase (e.g., “Hey H App”) signals the system to prepare for voice input without requiring the user to touch the screen. Alternatively, the user may tap the floating Ask AI control 150 to manually initiate voice input.

At step S420, the user speaks a natural-language query. The speech is captured by a microphone on client device 110 and streamed to speech-to-text engine 170. In a preferred embodiment, speech-to-text engine 170 performs real-time streaming transcription, and incremental transcription may be displayed on the screen as the user speaks, providing immediate feedback.

At step S430, the transcribed query is processed through the pipeline described in FIG. 3 (retrieval, generation, fidelity validation). The response-generation engine 250 produces a validated response, which is passed to output renderer 300.

At step S440, the validated response is delivered to the user via text-to-speech engine 320 as spoken output. Simultaneously, the synchronized text of the response may be displayed on the screen. The voice interaction controller is configured to support continuous duplex or semi-duplex interaction, meaning the user can interrupt, pause, replay, or adjust the speed of the spoken output. For example, the user may say “pause” or “say that again,” or may tap a replay button on the screen to hear the response repeated. Variable-speed playback allows users to slow down the speech for better comprehension.

At step S450, after listening to the spoken response, the user may issue a follow-up voice command. For example, the user may say “post that to my feed” or “send that as a reply.” In response, the multimodal publishing pipeline 340 converts the validated response into the requested publishable social artifact, and the system may provide spoken confirmation, such as “Posted to your feed.”

In certain embodiments, the voice interaction controller supports continuous duplex interaction, including wake-phrase re-entry, playback pause, replay, variable-speed playback, automatic repeat prompting, optional dialect adaptation, and low-literacy playback adjustment while the user remains in the active social session.

For users operating in an elderly mode controlled by elderly mode controller 430, the system may automatically apply additional adaptations during this voice-first interaction. These adaptations include enlarged on-screen controls for replay and pause, high-contrast visual themes, simplified-language output via simplified-language renderer 310, slower default speech rate, and automatic repetition of the spoken response if no user input is detected within a timeout period. The system may also proactively offer a spoken prompt such as “Would you like me to repeat that?” or “Would you like to share this answer?”

This voice-first interaction mode significantly reduces the cognitive and physical barriers to accessing AI assistance, enabling users who may be uncomfortable with typing or complex touch interfaces to benefit fully from the axiom-locked guidance provided by the platform, all while remaining within their familiar social application environment.

In certain embodiments, the system further comprises an elderly mode controller and an elderly or accessibility mode toggle associated with a user profile state. When the elderly or accessibility mode is active, the system may automatically enable one or more of enlarged controls, simplified-language rendering, automatic repetition, slowed text-to-speech playback, optional dialect adaptation, high-contrast display formatting, or low-literacy playback adjustment. The system may also provide spoken confirmation prompts or replay prompts to facilitate comprehension by elderly or low-literacy users while the user remains inside the active social session.

### VI. Multimodal Publishing Pipeline (FIG. 5)

Referring now to FIG. 5, a detailed diagram of the multimodal publishing pipeline 340 is shown. The pipeline receives a validated response from the output renderer 300 or directly from the fidelity validator 270 and transforms it into one or more publishable social artifacts that can be disseminated within the same application session without requiring the user to manually copy, edit, or export content.

The pipeline begins with a validated response object R1, which contains the text, structured data, formatting metadata, and optionally media generation instructions derived from the candidate response object 260 after passing fidelity validation.

The validated response object R1 is first routed to a content classifier 510, which analyzes the content to determine the most suitable publication formats. The content classifier 510 may consider factors such as the length of the response, the presence of structured data (e.g., bullet points, numbered steps, tabular information), the inferred user intent (e.g., whether the response answers a factual question, provides a plan, or offers guidance), and explicit user preferences.

Based on the classification, the validated response is directed to one or more transformation modules. In the embodiment shown, the pipeline includes post composer 350, short-video generator 360, subtitle generator 370, message/reply transformer 470, live-stream overlay generator 480, and group or chat publishing adapter 490. Each of these modules produces a different type of publishable social artifact.

The post composer 350 generates a social media post suitable for a feed or story. This may be a short text post with an optional attached card, a longer article-style post, or a shareable image card containing a summary of the response. The post composer 350 may also apply axiom-based quality filtering to ensure that the content promoted to the public feed aligns with the authoritative corpus and meets quality thresholds.

The short-video generator 360 automatically produces a short-form video (e.g., 15 to 60 seconds in duration) based on the validated response. The video generation process includes: generating a narration script from the response text; synthesizing a voiceover using text-to-speech engine 320; selecting or generating background visuals (e.g., animated text, relevant stock imagery, graphical cards generated by dashboard generator 330); and assembling the components into a video file. Subtitle generator 370 may automatically create closed captions or burned-in subtitles for the video, ensuring accessibility.

The message/reply transformer 470 converts the validated response into a format suitable for private messages or chat replies. This may involve truncating the response for brevity, formatting it as a threaded reply, or adding a “sent via AI” badge.

The live-stream overlay generator 480 produces an overlay graphic or text that can be displayed during a live broadcast, allowing a streamer to share AI-generated insights with their audience in real time.

The group or chat publishing adapter 490 formats the content for group discussions, ensuring compatibility with group-specific formatting and notification settings.

Each transformation module outputs a publishable artifact, which is temporarily stored as a draft package 520. The draft package 520 is presented to the user via a preview interface generated by share/export controller 380. The user may view a visual preview of the AI-generated content before publication, edit the content if desired, select a destination (e.g., personal feed, group chat, story), and then trigger publication with one or a few taps.

In certain embodiments, the preview interface presents a preview pane, a compliance badge state, and one or more destination-specific controls selected from a feed control, a group control, a chat control, a story control, or a live-stream control, and publication is selectively blocked until a required pre-publication compliance state is satisfied.

Upon user confirmation, the approved artifact is routed to the appropriate social destination 530 (e.g., feed, story, private message thread, group) through the social session manager 120. The provenance and audit module 390 records the publication event, including which corpus segments were used to generate the original response, the validation outcome, and any user modifications made prior to publication.

### VII. Personalized Dashboard and Safety Compliance (FIG. 6)

Referring now to FIG. 6, a personalized dashboard and safety-compliance interface is illustrated. This dashboard, generated at least in part by dashboard generator 330 and compliance badge generator 400, provides the user with a consolidated view of AI-generated guidance, system status, and assurance of content fidelity.

The dashboard may be accessed via a dedicated tab within the social interface or may appear as a summary panel after an AI interaction. The dashboard comprises several visual components, each with a specific function.

A user status summary 610 presents a high-level overview of the user's recent interactions with the AI system. This may include a count of questions asked, topics explored, or guidance received. In some embodiments, the user status summary 610 includes personalized metrics derived from the user profile state store 460, such as areas of interest or recurring concerns.

One or more guidance cards 620 are displayed, each representing a validated response that has been transformed into a user-specific visual indicator. For example, a guidance card 620 may contain a succinct answer to a previously asked question, a recommended next step, or a daily insight drawn from the authoritative axiom corpus. Action-button generator 450 may attach interactive buttons to each guidance card 620, enabling the user to take immediate action, such as “Learn More,” “Apply This to My Plan,” or “Share This.”

A safety shield visual indicator 630 is prominently displayed. This indicator, generated by compliance badge generator 400, provides the user with immediate visual confirmation that the content presented in the dashboard has passed the fidelity validation stage and complies with the safety axioms contained within the authoritative axiom corpus store 200. The safety shield visual indicator 630 may be a badge, an icon, or a color-coded status bar, and its presence signifies that the displayed guidance is traceable to the authoritative corpus and has not been hallucinated or derived from unverified sources.

A provenance section 640 may optionally be displayed, providing the user with transparency into the source of the guidance. For example, the provenance section 640 may list the specific corpus segments 210 that were retrieved to generate a particular answer, allowing the user to verify the basis of the guidance.

An elderly or accessibility mode toggle 650 may be present, allowing the user to quickly enable the adaptations managed by elderly mode controller 430, including enlarged controls, high-contrast UI, and simplified-language rendering.

The dashboard of FIG. 6 serves as a trust anchor within the H App ecosystem, reassuring users that the AI assistance they receive is not arbitrary or probabilistic but is grounded in a verifiable, authoritative, and safety-compliant knowledge base.

### VIII. Data Structures and Audit Trail (FIG. 7)

Referring now to FIG. 7, a data-structure diagram illustrates the key data objects and their relationships that enable the provenance and audit capabilities of the system. The provenance and audit module 390 relies on structured data to log interactions, support transparency, and facilitate compliance reporting.

The diagram shows a user invocation event record 710, which is created each time a user invokes the AI invocation interface 140. The user invocation event record 710 includes fields such as a unique event identifier, a user identifier, a timestamp, the type of invocation (e.g., tap on floating Ask AI control 150, voice wake phrase), and the social context at the time of invocation (e.g., feed position, active chat thread). This record establishes the beginning of an AI interaction session.

A query object 720 is created by input processor 160 after the user submits a query. The query object 720 contains the raw text of the query (as typed or transcribed by speech-to-text engine 170), a normalized version of the query produced by text query parser 180, and optionally a language identifier or other metadata.

Retrieval metadata 730 is generated by retrieval controller 220 during the retrieval stage. This metadata records which corpus segments 210 were retrieved in response to the query. For each retrieved segment, the metadata may include a segment identifier, a relevance score, and the version of the authoritative axiom corpus used. This information provides a direct link between the user's query and the source material used to generate the answer.

A candidate response object 260 is generated by response-generation engine 250. As previously described, this object contains the raw generated text and any structured formatting instructions. The candidate response object 260 is associated with the query object 720 and the retrieval metadata 730.

Validation metadata 740 is produced by fidelity validator 270 after evaluating the candidate response object 260. This metadata includes a fidelity score computed by support-score engine 280, an indication of whether any contradictions were detected by contradiction detector 290, and a final validation decision (e.g., approved, rejected, revised). The validation metadata 740 is linked to the candidate response object 260.

A validated response object 750 is the output of the fidelity validation stage. It contains the final text, formatting, and any annotations applied during validation. The validated response object 750 is associated with the validation metadata 740.

A publish package 760 is created when the user elects to publish content via multimodal publishing pipeline 340. The publish package 760 includes the final published artifact (e.g., a post, a video file, a message), a reference to the validated response object 750 from which it was derived, and any user modifications captured during the preview stage. The publish package 760 also records the destination of the publication (e.g., feed, group chat).

Provenance log entries 770 aggregate the records described above into a unified, time-sequenced log. The provenance and audit module 390 writes provenance log entries 770 to a persistent storage system. These entries may be used for audit purposes, for generating transparency reports to users, for compliance with regulatory requirements, or for debugging and improving the AI pipeline.

In certain embodiments, the persistent provenance log further stores a compliance badge state associated with a validated response or publish package 760, thereby allowing later reconstruction of whether a given artifact was approved, blocked, revised, or published under a particular compliance condition.

An offline cache 410 is also depicted, storing selected corpus fragments 210, query templates, prior validated responses 750, or publish packages 760 that have been queued for synchronization. Synchronization controller 420 manages the upload and download of data between offline cache 410 and remote servers when connectivity is restored.

In certain embodiments, the offline cache 410 supports provisional answering against a limited local cache of authoritative corpus fragments during reduced-connectivity conditions, and the synchronization controller 420 later refreshes, annotates, or updates the provisional answer when fuller connectivity or updated corpus material becomes available.

The structured data approach illustrated in FIG. 7 ensures that every AI-assisted interaction and publication event within the H App is fully traceable, verifiable, and auditable. This technical capability distinguishes the platform from conventional social and AI systems, providing a foundation of trust and accountability.

### IX. Enhanced Example Embodiments and User Scenarios

The following additional examples illustrate the practical application of the hybrid social-AI interaction platform across diverse user demographics and use cases, demonstrating the breadth and transformative potential of the present invention.

In one embodiment, illustrating the power of the platform for an ordinary user, a woman named “Ms. Chen,” a 55-year-old retired teacher with limited technical skills, hears about the H App from her daughter. She downloads it and is immediately greeted by a simple, visual-heavy interface. She sees her daughter's posts in the feed. One day, she sees a post about AI taking over jobs and feels a pang of anxiety about her grandson's future. She notices the floating Ask AI button 150. Hesitantly, she taps it. Instead of a keyboard, the app asks if she'd like to speak. She says, in her local dialect, “Will my grandson have a good job when he grows up?” The speech-to-text engine 170, configured for dialect adaptation via the elderly mode controller 430, accurately transcribes her query. Within seconds, a gentle voice responds via text-to-speech engine 320:“According to the 600+ Axioms, work will be a choice, and your grandson will have the opportunity to be a creator. Here is a simple guide on how to nurture his creativity now.” A guidance card 620 appears with simple bullet points and a “Save for Later” action button 450. She taps it, and a spoken confirmation says, “Saved to your dashboard.” She smiles and thinks, “I just ‘H’ed for the first time, and it was so easy.” Over the following weeks, she starts ‘H’ing daily, asking for simple recipes, home remedies based on safety axioms, and listening to axiom-based stories. The H App becomes her daily companion for hope and simple, actionable advice, all without her needing to type or navigate complex menus. The platform successfully onboarded a non-technical elderly user by reducing interaction friction.

In another embodiment, demonstrating the seamless social-AI integration and content flywheel, a young professional named “Alex” is scrolling through his feed on H App. He sees a post from a friend struggling with career burnout. Alex has also been feeling this way. He long-presses the friend's post, which brings up a context menu including an “Ask H about this” option. He selects it. The system 190 automatically takes the context of the post (“career burnout”) and pre-populates a query in the AI invocation interface 140:“I'm feeling this way too. What are steps to find meaningful work again?” Alex submits the query. The retrieval controller 220 fetches relevant axioms about “work-life balance,” “intrinsic motivation,” and “cognitive wealth.” The response-generation engine 250 creates a structured, multi-step plan. Alex reviews the validated response, and with a single tap on the “Create Video” button, the short-video generator 360 produces a 45-second video. The video uses a calm voiceover, soothing background visuals, and animated text summarizing the key steps. Alex posts this video to his feed. Within hours, several of his friends and followers, who also silently struggle with burnout, see the video, find it helpful, and tap the “Ask Follow-Up” button on the video's overlay. This creates a viral, virtuous cycle—the content flywheel—where one user's validated, anxiety-addressing query becomes the starting point for many others to engage with the AI, all within the same social ecosystem.

In another embodiment, highlighting the fidelity validation and compliance features, a popular financial influencer on H App, “Mr. Tan,” is preparing a live stream about investing in the age of AI. He wants to provide his audience with a definitive, trustworthy answer to the question, “Is my money safe?” During his live stream preparation, he uses the AI invocation interface 140. He asks, “Explain how the World New Financing OS protects individual assets.” The retrieval controller 220 pulls the precise axioms related to financial sovereignty and asset protection. The fidelity validator 270 confirms the response is 100% supported. Before Mr. Tan goes live, he opens the dashboard and sees the response displayed as a guidance card 620 with the prominent safety shield visual indicator 630. During his live stream, he shares his screen, displaying the dashboard. He points to the shield and says, “This isn't just my opinion. This answer is verified and locked to the Civilization 5.0 operating system.” This visual proof of fidelity builds immense trust with his audience. Furthermore, because the system is in a protected response mode, Mr. Tan cannot accidentally or intentionally generate financial advice that is outside the bounds of the authoritative corpus, protecting both him and his followers from misinformation.

In another embodiment, demonstrating the voice-first interaction for learning and accessibility, a 12-year-old student named “Maya” uses H App to help with her homework. She is dyslexic and finds reading large amounts of text challenging. She invokes the AI using the wake phrase “Hey H.” She asks, “Explain the theory of relativity in a simple way.” The system 250 generates a response. The output renderer 300, detecting that Maya's profile has the elderly/accessibility mode toggle 650 enabled, automatically activates the simplified-language renderer 310 and the text-to-speech engine 320. A friendly voice explains the core concept using analogies and simple words, while the screen shows a synchronized, high-contrast text summary. Maya can say “pause,” “repeat,” or “explain that last part again.” The voice interaction controller allows her to learn at her own pace without the barrier of text. She can then say, “create a flashcard for this,” and the multimodal publishing pipeline 340 generates a visual card summarizing the key points, which she can save to her private dashboard. This embodiment shows how the platform is not just for the elderly but for anyone who benefits from multimodal, voice-first, and accessible interfaces.

In another embodiment, illustrating the offline cache and provenance features, a journalist named “Elena” is in a remote area with intermittent internet connectivity, investigating the impact of a new infrastructure project on a local community. She wants to understand the project's alignment with the Civilization 5.0 axioms on environmental sustainability. While offline, she uses H App to query, “What are the axioms regarding ecological balance and large-scale construction?” The offline cache 410, which had previously synced a subset of the core Safety and Prosperity axioms, allows the retrieval controller 220 to provide a provisional answer based on the locally stored fragments. A “provisional answer” badge is displayed. She drafts a post containing the community's concerns alongside the axiom-based standards, but the publish package 760 is queued locally. Later, when she regains connectivity, the synchronization controller 420 uploads her post. The provenance and audit module 390 records the entire event, including the fact that the answer was generated offline from a specific version of the cached axioms. When the post goes live, viewers can see the provenance trail, understanding the source and any limitations of the information. This builds trust even in challenging environments.

In another embodiment, demonstrating the system's ability to handle emotionally charged and sensitive situations, a user “Sarah” is experiencing a moment of acute panic and anxiety late at night. She whispers to her device, “I'm feeling really scared and alone right now.” The anxiety classification engine 2030, implemented here as a specialized sub-module within the input processor 160 or as a separate service, detects the high emotional distress and low actionability. The system does not attempt to generate complex advice. Instead, the response-generation engine 250, guided by a specific “Crisis Support” set of axioms, generates a simple, calming, and immediate intervention. The validated response is rendered as a soothing voice via the text-to-speech engine 320:“You are not alone. According to the Safety Kernel, your well-being is the highest priority. Let's take a slow breath together: inhale . . . exhale . . . Would you like me to connect you with a real person to talk to, or shall we just sit here quietly for a moment?” The action-button generator 450 presents two large, clear buttons: “Connect Me” and “Just Breathe.” If Sarah selects “Connect Me,” the routing engine 2060 (integrated into this social platform) uses the escalation pathway 2074 to securely and anonymously connect her with a certified human crisis counselor via an in-app voice call. This seamless transition from AI-guided de-escalation to human professional support, all within the safe context of the app, represents a profound improvement over generic chatbots that may offer unhelpful or even harmful advice in such critical moments.

### X. Technical Advantages and Improvements

The present invention provides numerous technical advantages over conventional systems and methods for social and artificial-intelligence interaction.

First, the invention substantially reduces context-switching overhead. By maintaining the AI invocation interface 140 as an always-available overlay within the social session, users are not required to exit the social application, navigate to a separate chatbot or search tool, and then manually return. The session context buffer 190 preserves the user's position, minimizing cognitive disruption and improving overall user efficiency.

Second, the invention improves the reliability and trustworthiness of AI-generated content within a social environment. The combination of retrieval controller 220 restricted to an authoritative axiom corpus store 200 and fidelity validator 270 ensures that generated responses are grounded in a verifiable source of truth. The support-score engine 280 and contradiction detector 290 provide technical safeguards against hallucinations and unsupported claims. This represents a significant improvement over conventional AI chatbots, which may generate plausible-sounding but factually incorrect or unverified information.

Third, the invention enhances accessibility for elderly, low-literacy, and non-technical users. The voice-first interaction mode depicted in FIG. 4, combined with elderly mode controller 430, simplified-language renderer 310, and text-to-speech engine 320, reduces barriers to entry. Users can receive complex, axiom-based guidance through simple spoken dialogue, without needing to read lengthy documents or navigate complex menus.

Fourth, the invention accelerates the content creation and sharing cycle. The multimodal publishing pipeline 340 enables users to transform a validated response into a publishable social artifact—such as a post, video, or message—with one or a few actions, all within the same application session. This seamless integration encourages user engagement and facilitates the rapid dissemination of authoritative information through social networks.

Fifth, the invention provides a verifiable audit trail and provenance framework. The provenance and audit module 390, together with the data structures depicted in FIG. 7, allows the system to log and retrieve a complete record of each AI interaction and publication event. This capability supports transparency, compliance, and continuous improvement of the AI models and retrieval systems.

Sixth, the invention provides a platform for delivering personalized, life-critical guidance at scale. By constraining responses to an authoritative axiom corpus that addresses work, education, family, health, and future planning, the system can provide millions of users with consistent, high-quality guidance tailored to their individual queries, while maintaining strict fidelity to the underlying corpus.

These technical advantages collectively represent a substantial improvement in the field of computer-implemented social and artificial-intelligence platforms.

### XI. Additional Technical Clarifications and Implementation Flexibility

The present invention provides a concrete technical improvement over conventional social applications and conventional AI chatbot interfaces by maintaining the user within an active social session while performing corpus-bounded retrieval, candidate generation, fidelity validation, compliance gating, multimodal rendering, and destination-specific publication. Unlike a generic social platform that merely embeds a chatbot widget or a generic chatbot that merely produces conversational output, the present system enforces an authoritative-corpus response mode, optionally excludes external third-party model execution, generates a publication-eligibility state, visually indicates compliance prior to publication, and stores structured provenance objects that permit full reconstruction of the AI-assisted publication process.

For avoidance of doubt, the H AI engine, the fidelity validator, the support-score engine, the contradiction detector, the compliance badge generator, the action-button generator, the user invocation event record, the query object, the retrieval metadata, the validation metadata, the publish package, and the provenance and audit module may each be implemented by one or more software components, hardware components, firmware components, service components, or distributed components, provided that such implementation performs the recited function. Unless expressly stated otherwise, references herein to a protected response mode, a bounded sole-authority mode, a compliance-gated mode, a preview state, a guidance package, a guidance card, a safety shield visual indicator, or a provenance object encompass one or more equivalent structures, machine-readable records, or execution states sufficient to perform the corresponding disclosed function.

### XII. Compliance With 35 U.S.C. § 101 and § 112

The specification and claims of this patent application fully comply with the requirements of 35 U.S.C. § 101 (Patent Eligibility) and § 112 (Specification Requirements).

1. Argument for Compliance With 35 U.S.C. § 101 (patent Eligibility)

35 U.S.C. § 101 provides that any new and useful process, machine, manufacture, or composition of matter, or any new and useful improvement thereof, may be patented. However, judicial exceptions preclude the patenting of abstract ideas, laws of nature, or natural phenomena. The present invention does not attempt to patent an abstract idea (such as “social networking” or “question-and-answer”), but rather provides a specific, computer-implemented technical solution for addressing specific technical problems present in computer-aided social and artificial-intelligence interaction systems.

The claims of the present invention are directed to an improved computer system and method comprising specific, structured components such as a “Social Session Manager 120,” “Session Context Buffer 190,” “AI Invocation Interface 140” (which includes a persistently displayed “Ask AI” Floating Control 150), “Authoritative Axiom Corpus Store 200,” “Fidelity Validator 270,” and “Multimodal Publishing Pipeline 340.” These components operate in concert to allow a user, while maintaining their active social session context, to seamlessly invoke an AI assistant constrained to an authoritative knowledge base, receive a validated answer, and convert that answer into social content with a single action. This is not merely “automating” an abstract business practice (such as “seeking advice and sharing”), but rather provides a new computer functionality architecture that transcends the capabilities of traditional computer interfaces. For example, the post-generation, pre-publication compliance gating of AI content by the “Fidelity Validator 270” and the visual assurance of certainty provided by the “Compliance Badge Generator 400” represent technical improvements that existing social platforms or AI chatbots cannot provide. This architecture significantly reduces the user's computational context-switching overhead and provides unprecedented transparency and auditability through structured provenance data 710-770.

Therefore, the claims of the present invention are rooted in a specific application of computer technology, providing a specific improvement to the functionality of computer-aided social and AI interaction systems, rather than an abstract idea. They satisfy the two-step Alice/Mayo test: first, the claims are directed to a specific technical implementation (rather than an abstract idea); second, even if deemed to involve an abstract idea, elements such as the “Persistently Displayed Interaction Control,” “Session Context Buffer,” “Authoritative Corpus Retrieval and Verification,” “Multimodal Publishing Pipeline,” and “Structured Provenance Objects” provide an “inventive concept” that transforms the claim into patent-eligible subject matter. Accordingly, the present invention fully satisfies the requirements of 35 U.S.C. § 101.

2. Argument for Compliance with 35 U.S.C. § 112 (Specification Requirements)

35 U.S.C. § 112(a) requires the specification to contain a written description of the invention, and of the manner and process of making and using it, in such full, clear, concise, and exact terms as to enable any person skilled in the art to make and use the invention. The specification of the present invention fully satisfies this “enablement” requirement.

First, the specification provides an extremely detailed description of the system architecture (see FIG. 1 and related paragraphs), clarifying the structure and function of each functional module (e.g., 120, 190, 270, 340, 430). Second, through detailed descriptions of multiple flowcharts (FIG. 2, FIG. 3, FIG. 4) and data processing flows (FIG. 5, FIG. 7), a person skilled in the art can clearly understand how data flows and is processed within the system. Third, the specification provides abundant data structure examples (FIG. 7 and related paragraphs), such as “User Invocation Event Record 710,” “Validation Metadata 740,” “Publish Package 760,” defining the key data objects on which system operation depends. Finally, through multiple vivid embodiments covering different user demographics and use cases ([0044]-[0049]), the specification demonstrates how the present invention is practically applied, providing ample guidance to a person skilled in the art. 35 U.S.C. § 112(b) requires the claims to particularly point out and distinctly claim the subject matter which the applicant regards as his invention. The claims of this patent application (inserted herein or incorporated by reference) define the boundaries of the present invention in clear and unambiguous language, distinctly identifying the various technical features and their combinations. Therefore, the specification of the present invention fully satisfies all requirements of 35 U.S.C. § 112.

What is claimed is:

1. A computer-implemented hybrid social-artificial-intelligence interaction system, comprising:
(a) a social session manager configured to maintain an active user session in a social interface;
(b) an invocation interface configured to receive a user command to invoke artificial-intelligence assistance without exiting said social interface;
(c) an input processor configured to receive a user query in text, speech, or both;
(d) a corpus store comprising an authoritative axiom corpus;
(e) a retrieval controller configured to retrieve one or more corpus segments from said corpus store responsive to said user query;
(f) a response-generation engine configured to generate a candidate response using at least said user query and said one or more corpus segments;
(g) a fidelity validator configured to evaluate whether said candidate response satisfies one or more faithfulness criteria with respect to said one or more corpus segments or said authoritative axiom corpus;
(h) an output renderer configured to render a validated response within said social interface; and
(i) a publishing pipeline configured to convert at least part of said validated response into a publishable social artifact within the same application session,
wherein, in a protected response mode, all artificial-intelligence responses are generated solely by an H AI engine locked to the authoritative axiom corpus and the system is configured to prohibit execution of any external third-party large language model API for generation of protected responses,
wherein the fidelity validator is further configured to set a publication-eligibility state, and
wherein the system further comprises a compliance badge generator configured to generate a visible pre-publication compliance indicator for a validated response, wherein the system enables seamless integration of social interaction and AI-assisted response generation within a unified interface, supports continuous voice duplex interaction, and creates a content-generation and publishing flywheel within the same application session.

2. A computer-implemented method for hybrid social-artificial-intelligence interaction, comprising:
(a) maintaining a user inside an active social session;
(b) receiving, during said active social session, an invocation of an artificial-intelligence assistant;
(c) receiving a user query without forcing said user to exit said active social session;
(d) retrieving one or more corpus segments from an authoritative corpus responsive to said user query;
(e) generating a candidate response using at least said user query and said one or more corpus segments;
(f) validating said candidate response for faithfulness to said authoritative corpus;
(g) rendering a validated response inside said active social session; and
(h) selectively converting said validated response into a publishable social artifact in said same application session, wherein the step of generating further comprises generating a user-specific guidance package responsive to a personal-life query concerning work, education, family, inheritance, health, or future planning, wherein the method further comprises, before dissemination of said publishable social artifact, generating a pre-publication compliance state, generating a preview state including one or more share options and one or more destination-specific publication controls, and selectively blocking publication when said pre-publication compliance state is not satisfied,
and wherein, in a protected response mode, said candidate response is generated solely by an H AI engine locked to said authoritative corpus and not by any external third-party large language model API.

3. A non-transitory computer-readable medium storing instructions that, when executed by one or more processors, cause the one or more processors to perform operations for hybrid social-artificial-intelligence interaction, the operations comprising:
(a) maintaining a user inside an active social session;
(b) receiving, during said active social session, an invocation of an artificial-intelligence assistant;
(c) receiving a user query without forcing said user to exit said active social session;
(d) retrieving one or more corpus segments from an authoritative corpus responsive to said user query;
(e) generating a candidate response using at least said user query and said one or more corpus segments;
(f) validating said candidate response for faithfulness to said authoritative corpus;
(g) rendering a validated response inside said active social session; and
(h) selectively converting said validated response into a publishable social artifact in said same application session, wherein the instructions further cause the one or more processors to generate a user invocation event record, a query object, retrieval metadata, validation metadata, a publish package, and a compliance badge state associated with said publishable social artifact.

4. The system of claim 1, wherein said invocation interface comprises a persistent floating control displayed over said social interface.

5. The system of claim 1, wherein said input processor comprises a speech-to-text engine configured to transcribe spoken input in real time while said user remains in said social interface.

6. The system of claim 1, wherein said output renderer comprises a text-to-speech engine configured to deliver spoken output while concurrently displaying synchronized text and wherein the voice interaction controller is configured to support continuous duplex interaction including playback pause, replay, variable-speed playback, or wake-phrase activation, automatic repeat prompting, optional dialect adaptation, or low-literacy playback adjustment under an elderly or accessibility mode.

7. The system of claim 1, wherein said fidelity validator is configured to reject, revise, annotate, or confidence-score said candidate response when said candidate response is insufficiently supported by retrieved corpus segments, and wherein said fidelity validator is further configured to set a publication-eligibility state and to prevent publication through said publishing pipeline when a required fidelity, support, contradiction, or compliance condition is not satisfied.

8. The system of claim 1, wherein said publishing pipeline is configured to generate, from said validated response, at least one of: a short post, a long-form post, a direct-message reply, a group-message reply, a story card, a short-form narrated video, a subtitle track, a live-stream overlay, or an infographic panel and wherein the publishing pipeline is further configured to automatically generate a short-form video that includes synthesized narration, captions, and one or more visual elements derived from said validated response, invoke a share/export controller, invoke a group or chat publishing adapter, and present a pre-publication preview state before final dissemination of said publishable social artifact.

9. The system of claim 1, further comprising a simplified-language renderer configured to transform said validated response into a readability-adjusted format suitable for a low-literacy or non-technical user, wherein activation of said simplified-language renderer is selectively controlled by an elderly mode controller and an elderly or accessibility mode toggle associated with a user profile state.

10. The system of claim 1, further comprising a voice interaction controller configured to support continuous duplex interaction including playback pause, replay, variable-speed playback, or wake-phrase activation, including wake-phrase re-entry, automatic repeat prompting, optional dialect adaptation, and low-literacy playback adjustment under an elderly or accessibility mode.

11. The system of claim 1, further comprising a dashboard generator configured to convert said validated response into one or more user-specific visual indicators, guidance cards, or action lists and wherein the dashboard generator is further configured to display a safety shield visual indicator verifying compliance with one or more safety axioms from the authoritative axiom corpus, and one or more action buttons generated by an action-button generator.

12. The system of claim 1, wherein the fidelity validator comprises a support-score engine to determine whether propositions in the candidate response are sufficiently supported by the retrieved one or more corpus segments and a contradiction detector configured to identify statements in the candidate response that conflict with the authoritative axiom corpus, and wherein the fidelity validator is further configured to generate validation metadata recording at least a fidelity score, a support score, a contradiction status, a compliance state, and one or more retrieved corpus identifiers.

13. The method of claim 2, wherein step (c) comprises receiving speech input and displaying incremental transcription while a feed, video, or chat remains visible in the background, wherein the incremental transcription is optionally accompanied by simplified-language transformation or spoken confirmation prompts when an elderly or accessibility mode is active.

14. The method of claim 2, wherein step (f) comprises computing a fidelity score, a support score, or a contradiction indicator relative to said authoritative corpus, and generating validation metadata that records at least said fidelity score, said support score, said contradiction indicator, a compliance state, and one or more corresponding retrieved corpus identifiers.

15. The method of claim 2, wherein step (h) comprises automatically generating a short-form video that includes synthesized narration, captions, and one or more visual elements derived from said validated response, wherein the automatically generated short-form video is selectively withheld from publication until a compliance indicator is displayed.

16. The method of claim 2, wherein step (h) further comprises presenting a one-tap control for posting said publishable social artifact to a feed, chat, group, or story interface, together with a preview pane, a compliance badge state, and one or more destination-specific controls selected from a feed control, a group control, a chat control, a story control, or a live-stream control.

17. The method of claim 2, further comprising generating a user-specific guidance package responsive to a personal-life query concerning work, education, family, inheritance, health, or future planning, wherein the user-specific guidance package comprises a summary statement, one or more explanatory cards, one or more next-step cards, one or more action buttons, and one or more social-share options.

18. The non-transitory computer-readable medium of claim 3, wherein the instructions further cause the one or more processors to maintain a user inside a social interface while artificial-intelligence assistance remains continuously available, and to generate a user invocation event record, a query object, retrieval metadata, validation metadata, and a publish package associated with the publishable social artifact.

19. The system of claim 1, further comprising an offline cache configured to store selected corpus fragments, prompts, or prior validated responses for use during reduced-connectivity conditions, wherein the offline cache further supports provisional answering against a limited local cache of authoritative corpus fragments and later refresh or annotation of a provisional answer when full connectivity is restored.

20. The system of claim 1, further comprising a provenance and audit module configured to record at least one of: user invocation events, retrieval references, validation outcomes, publication events, or content-transformation steps, wherein said provenance and audit module is further configured to store, in a persistent provenance log, at least a user invocation event record, a query object, retrieval metadata, validation metadata, a publish package, and a compliance badge state.
